(19) United States
(12) Patent Application Publication
(10) Pub. No.: US 2026/0084330 A1
(43) Pub. Date: Mar. 26, 2026

(54) MULTI-FUNCTIONAL PAPER CUTTING DEVICE

(71) Applicant: Yong LIU, Jinhua (CN)

(72) Inventor: Yong LIU, Jinhua (CN)

(21) Appl. No.: 19/406,005

(22) Filed: Dec. 2, 2025

Related U.S. Application Data
(63) Continuation-in-part of application No. 19/028,256, filed on Jan. 17, 2025, now Pat. No. 12,508,732.
(63) Continuation-in-part of application No. 18/963,667, filed on Nov. 28, 2024, now Pat. No. 12,370,712.
(63) Continuation-in-part of application No. 18/797,836, filed on Aug. 8, 2024, now Pat. No. 12,263,609.

(30) Foreign Application Priority Data
Jan. 4, 2025 (CN) 202520015284.5

(51) Int. Cl. B26D 7/01; B26D 7/14; B26D 7/22; B65H 35/00

(52) U.S. Cl. CPC B26D 7/015; B26D 7/14; B26D 7/22; B65H 35/0026; B65H 35/008; B65H 2301/5151; B65H 2301/51532; B65H 2301/5154

(57) ABSTRACT

A multi-function paper cutting device that integrates tape cutting and paper cutting functions into a single unit. The device primarily includes a shell having a wall extending along its length direction, with two ends of the wall being a first end and a second end, respectively. Integrated on the shell are a tape cutting assembly and a paper cutting structure. The paper cutting structure includes a slit and a paper cutting blade. A paper pressing structure applies continuous downward pressure on the fed-in paper. The tape cutting assembly is arranged with a tape sleeve shaft for mounting a tape roll, and a blade fixing member on which a serrated blade is arranged for cutting the tape.

### CROSS REFERENCE TO RELATED APPLICATIONS

This application is a continuation-in-part of U.S. patent application Ser. No. 19/028,256, filed on Jan. 17, 2025, which is a continuation-in-part of U.S. patent application Ser. No. 18/963,667 filed on Nov. 28, 2024, which is a continuation-in-part of U.S. patent application Ser. No. 18/797,836 filed on Aug. 8, 2024, the entire contents of which are hereby incorporated by reference in its entirety.

### TECHNICAL FIELD

The present disclosure relates to the technical field of office tools and hand tools, and in particular, to a multi-functional paper cutting device that integrates tape cutting functionality and paper cutting functionality.

### BACKGROUND

In daily office work, study, or handicraft production, users often need to use both tape and paper cutting tools simultaneously. In traditional solutions, tape dispensers and paper cutters are usually two independent devices, which not only occupy space but are also inconvenient to operate—users need to switch between different tools, affecting efficiency.

### SUMMARY OF THE DISCLOSURE

The present disclosure provides the following technical solution: A multi-function paper cutting device, including:
a shell, having a wall; wherein the wall has a first end and a second end along a length direction of the wall;
a tape cutting assembly, arranged on the shell; wherein the tape cutting assembly is configured to rotatably retain a tape roll on the shell and to cut a tape released from the tape roll; and a paper cutting structure, including a slit and a paper cutting blade;
wherein the slit is defined in the wall; a width of the slit is defined by an upper part and a lower part of the wall, and the slit extends from the first end of the wall along the length direction of the wall towards the second end;
the paper cutting blade is arranged on an end of the slit, and a blade edge of the paper cutting blade faces an entrance of the slit; paper to be cut is configured to be inserted into the slit and cut by the paper cutting blade after passing through the slit.

In some embodiments, the device further includes:
a paper pressing structure, including a paper pressing vertical plate; wherein the paper pressing vertical plate is connected to at least one of an inner wall and an outer wall of the wall, and extends obliquely downwards from the upper part on an area corresponding to the slit; in the length direction, the paper pressing vertical plate at least partially covers the slit and terminate on a front end of the blade edge;
the paper pressing structure is configured to apply a continuous downward pressure on paper located on both sides of the slit, causing the paper guided into the slit to be bent downward, and provide auxiliary positioning.

In some embodiments, the device further includes:
a support structure, having a contact surface; wherein the contact surface is configured to contact a placement surface during paper cutting and to be slidable or rollable relative to the placement surface, and the support structure is further configured to support the shell and enable the shell to move stably on the placement surface.

In some embodiments, the device further includes:
a tip, correspondingly arranged on the entrance of the slit; wherein the tip has a sloping surface, and the sloping surface extends obliquely upward from an end of the tip towards the slit;
wherein the tip is configured to, in a case where the paper to be cut is pushed, lift the paper to be cut from the placement surface, enlarge an effective width of the entrance of the slit via the sloping surface, and guide the paper to be cut into the slit.

In some embodiments, the device further includes:
a grip portion, connected to the shell for a user to hold.

In some embodiments, the tape cutting assembly includes:
a tape sleeve shaft, connected to the shell; wherein the tape sleeve shaft is configured to detachably mount the tape roll and allow the tape roll to rotate smoothly around the tape sleeve shaft to release the tape; and
a blade fixing member, arranged on a same side as the tape sleeve shaft and fixedly connected to the shell; wherein a serrated blade is arranged on the blade fixing member, and the serrated blade is configured to cut the tape released from the tape roll.

In some embodiments, the blade fixing member is arranged with a smooth surface that is outwardly protruding on a side facing the tape sleeve shaft, and the smooth surface is configured for an end of the tape remaining after cutting to adhere to and be temporarily fixed.

In some embodiments, a sliding groove is defined on the shell, and the tape cutting assembly further includes a protective assembly; the protective assembly is slidably arranged in the sliding groove, and the protective assembly is configured to cover blade teeth of the serrated blade in a case where the serrated blade is in a non-cutting state.

In some embodiments, the protective assembly includes:
a sliding member, slidably arranged in the sliding groove; wherein in a case where an external force is applied, the sliding member moves along the sliding groove to expose the blade teeth of the serrated blade for cutting the tape.

In some embodiments, the sliding member is arranged with a slide rail matching with the sliding groove, and the sliding groove defines a movement range and direction of the sliding member;
wherein the protective assembly further includes:
a spring, cooperating with the sliding member; after the external force is removed, the spring applies a resetting elastic force to the sliding member, driving the sliding member to move back to an initial position, for re-covering the blade teeth of the serrated blade; and
a protective member, forming a shell part of the protective assembly, for accommodating and installing the sliding member and the spring, and providing support for the spring.

In some embodiments, the sliding member includes a spring mounting hole for mounting the spring.

In some embodiments, an outer end of the tape sleeve shaft is arranged with a flange extending radially outward, and the flange is configured to restrict the tape roll on the tape sleeve shaft.

In some embodiments, the tip protrudes outward relative to the first end of the shell.

### BRIEF DESCRIPTION OF THE DRAWINGS

Drawings, which form a part of the present disclosure, are provided to facilitate further understanding of the present disclosure. The schematic embodiments and descriptions of the present disclosure are intended to explain the present disclosure and do not constitute an undue limitation of the present disclosure.

FIG. 1 is a perspective view of a multi-function paper cutting device according to some embodiments of the present disclosure.

FIG. 2 is an exploded view of the multi-function paper cutting device according to some embodiments of the present disclosure.

FIG. 3 is a side view of the multi-function paper cutting device and an enlarged view of portion M according to some embodiments of the present disclosure.

FIG. 4 is a perspective view of another side of the multi-function paper cutting device in a non-tape-cutting state and an enlarged view of portion N according to some embodiments of the present disclosure.

FIG. 5 is a perspective view of another side of the multi-function paper cutting device in a tape-cutting state and an enlarged view of portion P according to some embodiments of the present disclosure.

FIG. 6 is an exploded view of a protective assembly in the multi-function paper cutting device according to some embodiments of the present disclosure.

FIG. 7 is a perspective view of the multi-function paper cutting device from another perspective according to some embodiments of the present disclosure.

### DETAILED DESCRIPTION

The present disclosure will be described in detail below with reference to the drawings and in combination with embodiments. The examples are provided by way of explanation of the present disclosure and are not intended to limit the present disclosure. In fact, it will be apparent to those skilled in the art that modifications and variations may be made to the present disclosure without departing from the scope or spirit of the present disclosure. For example, features shown or described as part of one embodiment may be used in another embodiment to yield yet another embodiment. Therefore, it is intended that the present disclosure covers such modifications and variations that fall within the scope of the appended claims and their equivalents.

In the description of the present disclosure, the terms “longitudinal”, “transverse”, “upper”, “lower”, “front”, “rear”, “left”, “right”, “vertical”, “horizontal”, “top”, “bottom”, etc. indicate orientation or positional relationships based on the orientation or positional relationships shown in the drawings. They are only for the convenience of describing the present disclosure and do not require that the present disclosure must be constructed and operated in a specific orientation, and therefore cannot be understood as a limitation of the present disclosure. The terms “connected”, “linked”, “arranged” used in the present disclosure should be understood broadly. For example, it may be a fixed connection or a detachable connection; it may be directly connected or indirectly connected through an intermediate component; it may be a wired electrical connection, a wireless electrical connection, or a wireless communication signal connection. Those skilled in the art can understand the specific meanings of the above terms according to the specific circumstances.

One or more examples of the present disclosure are shown in the accompanying drawings. The detailed description uses numerical and alphabetic references to refer to features in the drawings. Similar or similar labels in the drawings and description have been used to refer to similar or similar parts of the present disclosure. As used herein, terms such as “first”, “second” and “third” are used interchangeably to distinguish one component from another and are not intended to indicate the position or importance of individual components.

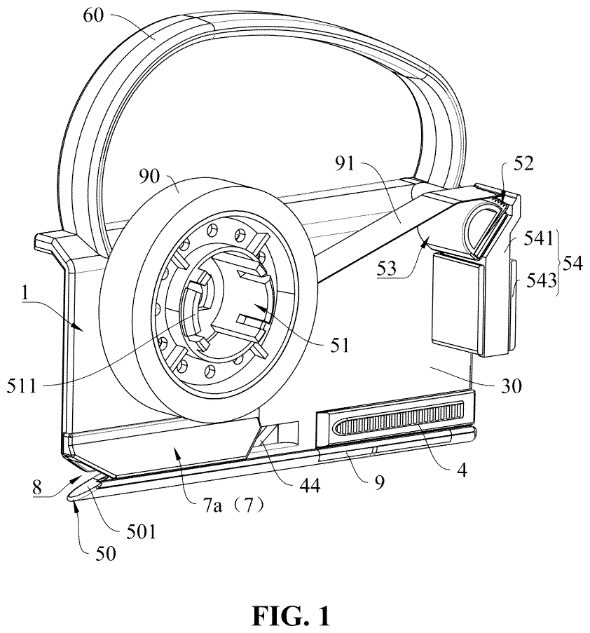

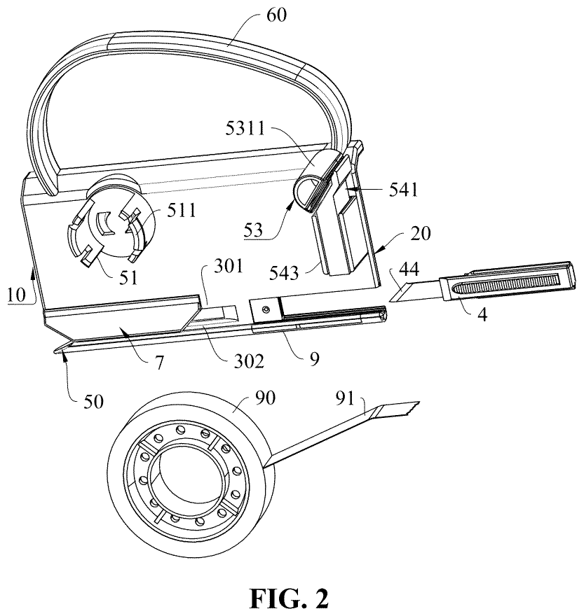

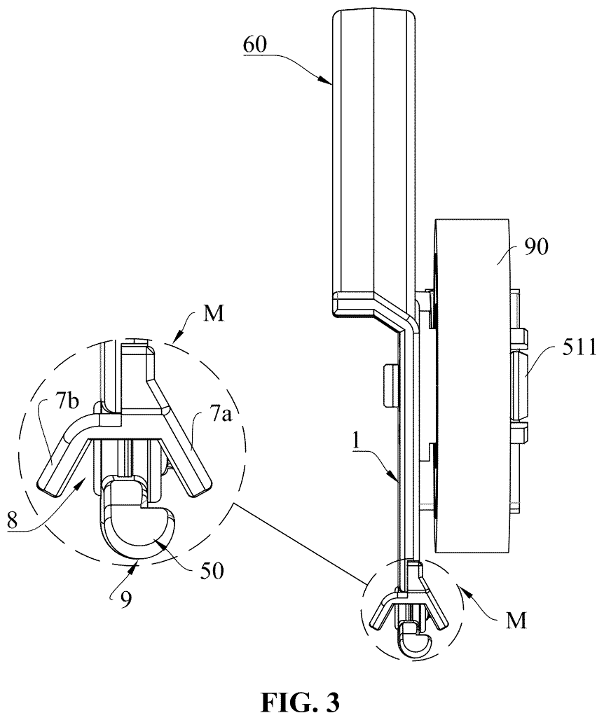

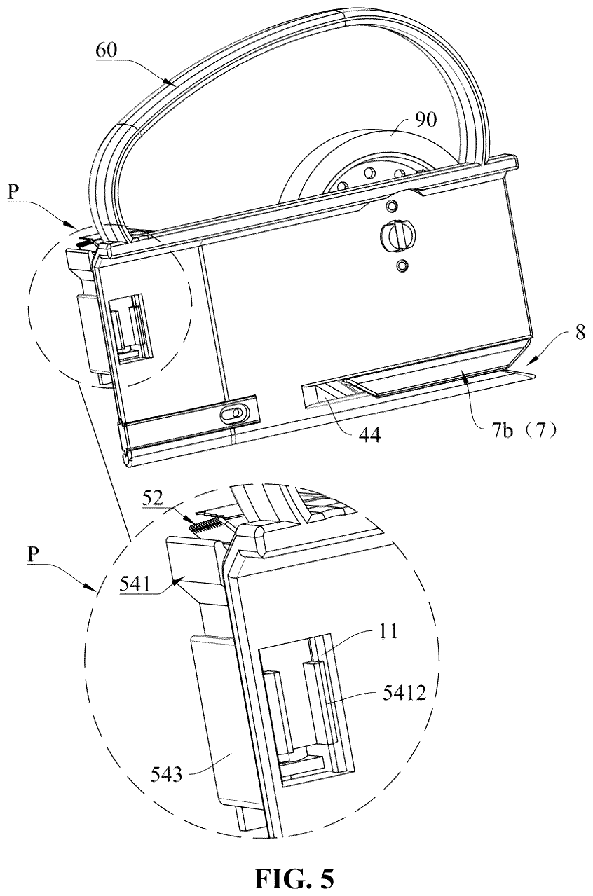

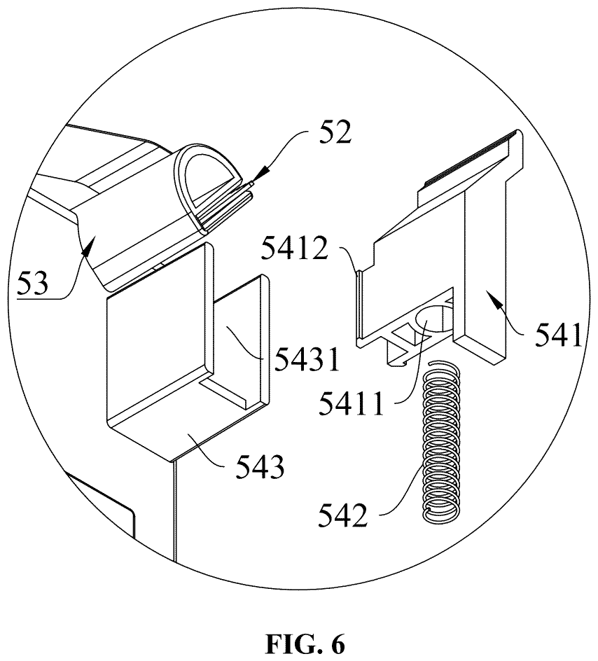

As shown in FIG. 1 to FIG. 7, according to some embodiments of the present disclosure, a multi-function paper cutting device is provided. It integrates two major functions: cutting tape and cutting paper. The multi-function paper cutting device includes a shell 1, which has a wall 30 extending along a length direction. The wall 30 is a structural component of the shell 1, and may specifically refer to any one or more continuous surfaces of the upper surface, front side wall, rear side wall, or left and right outer side walls of the shell 1. In some embodiments, the wall 30 may be an outer side wall of the shell 1 or may be arranged in an opening or groove defined on an upper surface of the shell 1, for bearing or guiding the paper or tape to be cut and cooperating with a cutting assembly arranged on the wall 30 to achieve stable cutting operation. In some embodiments, the wall 30 may be specifically at least one outer side wall of the shell 1. The wall 30 is configured for bearing or guiding the paper or tape to be cut and cooperates with a cutting assembly arranged at a corresponding position to achieve stable and smooth cutting operation.

Two ends of the wall 30 are a first end 10 and a second end 20, respectively. A tape cutting component and a paper cutting structure are integrated on the shell 1, realizing an integrated design of tape cutting and paper cutting functions. This integrated structure not only saves space but also significantly improves the efficiency of office or manual operations, avoiding the need for users to frequently switch between multiple tools. The integrated structure abandons the traditional practice in office scenarios where separate paper cutters and tape dispensers are needed, effectively solving problems such as tool dispersion, large space occupation, and cumbersome operation processes. Specifically, users can continuously complete the operations of applying tape and cutting paper on the same device without frequently changing tools or adjusting work positions, significantly improving the operational continuity and efficiency in office, study, or handicraft processes. In addition, as the two functional modules share the same shell 1 and partial structural support, the overall volume is compact, facilitating storage and portability, and reducing the user's usage cost and space burden. Furthermore, functional integration also reduces the number of parts required for manufacturing, which helps simplify the assembly process, reduce production costs, and improve product reliability.

As shown in FIGS. 1 to 5, the paper cutting structure includes a slit 8 defined within the wall 30 and a paper cutter blade 4 arranged on the shell 1. The slit 8 is defined in width by an upper part 301 and a lower part 302 of the wall 30 and extends a distance from the first end 10 towards the second end 20. A blade edge 44 of the paper cutter blade 4 faces an end of the slit 8. The paper to be cut can be inserted into the slit 8 and be cut by the blade edge 44 after passing through. This structure ensures that the paper can be accurately guided along a predetermined path and neatly cut, improving cutting precision. To further enhance the stability of paper guiding, the device is further arranged with a paper pressing structure 7, which includes a first paper pressing vertical plate 7a and a second paper pressing vertical plate 7b connected to an inner or outer wall of the wall 30. The first and second paper pressing vertical plates 7a, 7b extend obliquely downwards from the upper part 301 on an area corresponding to the slit 8, at least partially cover the slit 8, and terminate on a front end of the blade edge 44. When paper continues to enter the slit 8, the paper pressing structure 7 applies a continuous downward pressure on the paper. The paper can be smoothly guided in without the user needing to make additional adjustments or apply force to press the paper, reducing the operation difficulty, especially suitable for handling thin or soft materials. In addition, the paper pressing structure 7 can cause the paper to bend downward and obtain auxiliary positioning, effectively preventing the paper from shifting, lifting, or jamming, and ensuring the stability and consistency of the paper during the entire cutting process, thereby guaranteeing a neat cut and smooth operation.

In some embodiments, as shown in FIGS. 1-3 and 7, to facilitate the smooth entry of thin or soft paper into the slit 8, a tip 50 is arranged at an entrance of the slit 8, which protrudes outward from the first end 10 of the shell 1. The tip 50 has a sloping surface 501 that extends obliquely upward from an end of the tip 50 away from the slit 8 towards the slit 8. The tip 50 can lift the paper from a placement surface when the paper is pushed, and simultaneously enlarges the effective width of the entrance of the slit 8 through the sloping surface 501, serving a guiding function, thereby significantly reducing the insertion difficulty and the risk of jamming. Furthermore, a support structure 9 is arranged on a bottom of the device. A contact surface 9a of the support structure 9 contacts the placement surface during the paper cutting process and can slide or roll relative to the placement surface, allowing the shell 1 to move smoothly during operation, which is particularly suitable for cutting long sheets of paper, improving cutting precision and operational smoothness.

To facilitate user operation, in some embodiments, as shown in FIGS. 1-5 and 7, a grip portion 60 is arranged on the shell 1 for the user to hold to stably control the entire device for paper cutting or tape cutting. This design is ergonomic, helps apply force accurately, reduces hand fatigue, and improves the overall user experience.

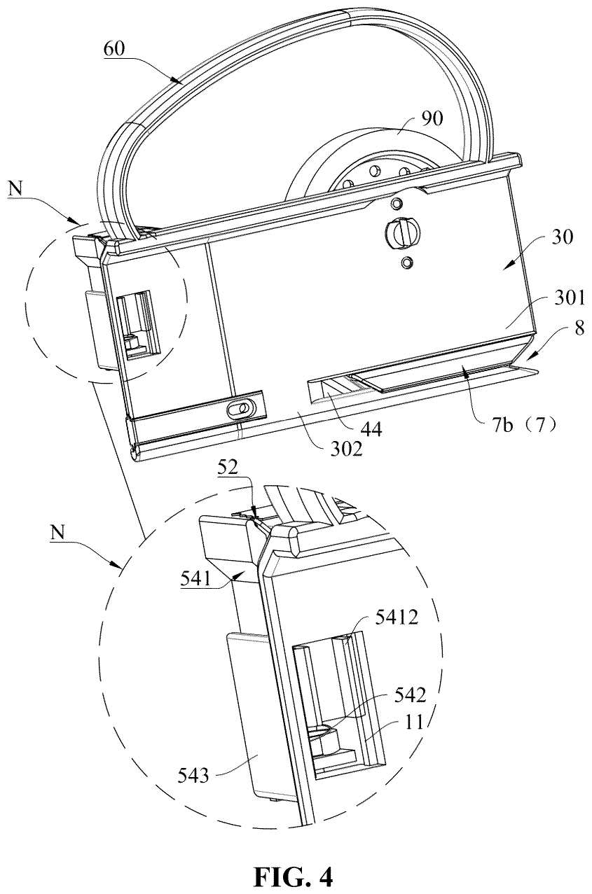

In some embodiments, as shown in FIGS. 4-6, the tape cutting assembly includes a tape sleeve shaft 51 and a blade fixing member 53. The tape sleeve shaft 51 is connected to the shell 1 for detachably mounting a tape roll 90 and allowing it to rotate smoothly around the tape sleeve shaft 51 to release a tape 91. An outer end of the tape sleeve shaft 51 is arranged with a radial flange 511 to effectively prevent the tape roll 90 from falling off during use. The blade fixing member 53 is fixed to the shell 1 and includes a serrated blade 52 for cutting the tape 91 that is pulled out from the tape roll 90. The structure of the serrated blade 52 is particularly suitable for cutting tough transparent tape, being labor-saving and efficient. Furthermore, a side of the blade fixing member 53 facing the tape sleeve shaft 51 is arranged with a protruding smooth surface 5311. After the tape 91 is cut, its end can temporarily adhere to the smooth surface 5311, preventing the tape 91 from retracting into the tape roll 90, thereby facilitating quick access next time.

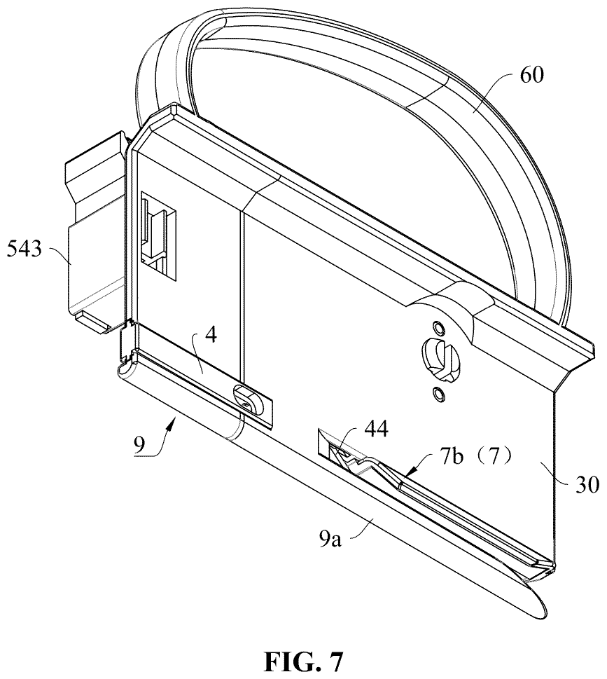

In some embodiments, the support structure 9 may be configured as any form suitable for support and movement, such as a pulley, roller, low-friction pad, or contact block with a smooth surface. As shown in FIG. 7, the main function of the support structure 9 is to contact the placement surface (e.g., desktop, workbench) through its contact surface 9a and allow the entire device to slide or roll smoothly when the user pushes the shell 1 to perform a paper cutting operation. This design helps maintain the linearity of the cutting path, especially suitable for continuous cutting of long sheets of paper. It should be noted that the present disclosure does not limit the specific structural form of the support structure 9. Any structure that can achieve the function of supporting the shell 1 and moving smoothly on the placement surface falls within the scope of the present disclosure.

To enhance safety, in some embodiments, as shown in FIGS. 4-6, a sliding groove 11 is defined on the shell 1, and a protective assembly 54 is slidably arranged in the sliding groove 11. The protective assembly 54 includes a sliding member 541, a spring 542, and a protective member 543. The sliding member 541 is arranged with a slide rail 5412 matching the sliding groove 11 and is assembled with the spring 542 via a spring mounting hole 5411. The protective member 543 forms a housing for accommodating and supporting the sliding member 541 and the spring 542. When the user applies force to push the sliding member 541, teeth of the serrated blade 52 are exposed, allowing tape cutting. After the force is released, the spring 542 drives the sliding member 541 to automatically reset, re-covering the blade teeth. This “press-to-use, release-to-close” mechanism may effectively prevent accidental cuts, balancing operational convenience and personal safety.

The working principle of the present disclosure is as follows: The multi-function paper cutting device disclosed in the present disclosure integrates the paper cutting function and the tape cutting function on the same shell 1 through an integrated structure. Users can flexibly switch between uses according to their needs, achieving efficient, safe, and convenient operation.

In a paper cutting mode, the user holds the grip portion 60 and aligns the paper to be cut with the tip 50 located at the first end 10 of the shell 1. The downward sloping surface 501 of the tip 50 slightly lifts the paper from the placement surface and guides it smoothly into the slit 8 defined by the upper part 301 and lower part 302 of the wall 30. As the paper continues to advance into the slit 8, the paper pressing structure 7, including the first paper pressing vertical plate 7a and the second paper pressing vertical plate 7b, applies a continuous downward pressure, keeping the paper pressed against the bottom of the slit 8 and maintaining a stable path, preventing shifting or lifting. When the paper passes through the slit 8 and reaches the end, the edge of the paper is cut by the blade edge 44 of the paper cutter blade 4 fixed on the shell 1, completing precise cutting. When a long sheet of paper is required to be cut, the user can push the device to slide along the placement surface. The contact surface 9a of the support structure 9 provides stable rolling or sliding support, ensuring a continuous and linear cutting process.

In a tape cutting mode, the tape roll 90 is mounted on the tape sleeve shaft 51, with its outer side limited by the flange 511 to prevent falling off. The user pulls out a required length of tape 91, passing it around the smooth surface 5311 on a side of the blade fixing member 53 (facilitating temporary adhesion of the end afterwards). When the tape 91 is required to be cut, the user presses inward on the sliding member 541 of the protective assembly 54, overcoming the force of the spring 542, for exposing the originally covered serrated blade 52. Then, pressing the tape 91 against the serrated blade 52 will easily cut the tape 91. After releasing the hand, the spring 542 automatically drives the sliding member 541 to reset, and the protective member 543 re-covers the teeth of the serrated blade 52, avoiding the risk of accidental contact and ensuring safety.

In summary, through clever structural layout and functional linkage, the proposed device may achieve a complete operational cycle within a single tool: accurate paper guiding-stable positioning-neat cutting for paper, and smooth tape dispensing-safe cutting-end pre-setting for tape. It combines practicality, safety, and user-friendliness.

Analysis shows that the present disclosure discloses a multi-function paper cutting device that not only solves problems such as single functionality, cumbersome operation, and safety hazards associated with traditional tools, but also achieves synergistic improvements in practicality, safety, economy, and human-machine interaction, demonstrating outstanding comprehensive technical effects.

The above are only some embodiments of the present disclosure and are not intended to limit the present disclosure. For those skilled in the art, the present disclosure may have various modifications and changes. Any modifications, equivalent replacements, improvements, etc., made within the spirit and principles of the present disclosure shall be included within the scope of the present disclosure.

What is claimed is:

1. A multi-function paper cutting device comprising:
a shell having a wall; wherein the wall has a first end and a second end along a length direction of the wall;
a tape cutting assembly arranged on the shell; wherein the tape cutting assembly is configured to rotatably retain a tape roll on the shell and to cut a tape released from the tape roll; and
a paper cutting structure comprising a slit and a paper cutting blade;
wherein the slit is defined in the wall; a width of the slit is defined by an upper part and a lower part of the wall, and the slit extends from the first end of the wall along the length direction of the wall towards the second end;
the paper cutting blade is arranged on an end of the slit, and a blade edge of the paper cutting blade faces an entrance of the slit; paper to be cut is configured to be inserted into the slit and cut by the paper cutting blade after passing through the slit.

2. The multi-function paper cutting device according to claim 1, further comprising:
a paper pressing structure comprising a paper pressing vertical plate; wherein the paper pressing vertical plate is connected to at least one of an inner wall and an outer wall of the wall, and extends obliquely downwards from the upper part on an area corresponding to the slit; in the length direction, the paper pressing vertical plate at least partially covers the slit and terminate on a front end of the blade edge;
wherein the paper pressing structure is configured to apply a continuous downward pressure on paper located on both sides of the slit, causing the paper guided into the slit to be bent downward, and provide auxiliary positioning.

3. The multi-function paper cutting device according to claim 1, further comprising:
a support structure having a contact surface; wherein the contact surface is configured to contact a placement surface during paper cutting and to be slidable or rollable relative to the placement surface, and the support structure is further configured to support the shell and enable the shell to move stably on the placement surface.

4. The multi-function paper cutting device according to claim 3, further comprising:
a tip, correspondingly arranged on the entrance of the slit; wherein the tip has a sloping surface, and the sloping surface extends obliquely upward from an end of the tip towards the slit;
wherein the tip is configured to, in a case where the paper to be cut is pushed, lift the paper to be cut from the placement surface, enlarge an effective width of the entrance of the slit via the sloping surface, and guide the paper to be cut into the slit.

5. The multi-function paper cutting device according to claim 1, further comprising:
a grip portion connected to the shell for a user to hold.

6. The multi-function paper cutting device according to claim 1, wherein the tape cutting assembly comprises:
a tape sleeve shaft connected to the shell; wherein the tape sleeve shaft is configured to detachably mount the tape roll and allow the tape roll to rotate smoothly around the tape sleeve shaft to release the tape; and
a blade fixing member arranged on a same side as the tape sleeve shaft and fixedly connected to the shell; wherein a serrated blade is arranged on the blade fixing member, and the serrated blade is configured to cut the tape released from the tape roll.

7. The multi-function paper cutting device according to claim 6, wherein the blade fixing member is arranged with a smooth surface that is outwardly protruding on a side facing the tape sleeve shaft, and the smooth surface is configured for an end of the tape remaining after cutting to adhere to and be temporarily fixed.

8. The multi-function paper cutting device according to claim 6, wherein a sliding groove is defined on the shell, and the tape cutting assembly further comprises a protective assembly; the protective assembly is slidably arranged in the sliding groove, and the protective assembly is configured to cover blade teeth of the serrated blade in a case where the serrated blade is in a non-cutting state.

9. The multi-function paper cutting device according to claim 8, wherein the protective assembly comprises:
a sliding member, slidably arranged in the sliding groove; wherein in a case where an external force is applied, the sliding member moves along the sliding groove to expose the blade teeth of the serrated blade for cutting the tape.

10. The multi-function paper cutting device according to claim 9, wherein the sliding member is arranged with a slide rail matching with the sliding groove, and the sliding groove defines a movement range and direction of the sliding member;
wherein the protective assembly further comprises:
a spring configured to cooperate with the sliding member; after the external force is removed, the spring applies a resetting elastic force to the sliding member, driving the sliding member to move back to an initial position, for re-covering the blade teeth of the serrated blade; and
a protective member configured to form a shell part of the protective assembly, for accommodating and installing the sliding member and the spring, and providing support for the spring.

11. The multi-function paper cutting device according to claim 10, wherein the sliding member comprises a spring mounting hole for mounting the spring.

12. The multi-function paper cutting device according to claim 11, wherein an outer end of the tape sleeve shaft is arranged with a flange extending radially outward, and the flange is configured to restrict the tape roll on the tape sleeve shaft.

13. The multi-function paper cutting device according to claim 4, wherein the tip protrudes outward relative to the first end of the shell.
